(19) United States
(12) Patent Application Publication
(10) Pub. No.: US 2011/0172340 A1
(43) Pub. Date: Jul. 14, 2011

(54) SILICONE RUBBER COMPOSITIONS

(76) Inventor: Michael Proctor, Vale Glamorgan (GB)

(21) Appl. No.: 12/992,358

(22) PCT Filed: May 14, 2009
(86) PCT No.: PCT/GB09/50519

§ 371 Date: Mar. 31, 2011

(30) Foreign Application Priority Data
May 14, 2008 (GB) GB0808682.9
May 14, 2009 (GB) PCT/GB2009/050519

(51) Int. Cl. C08K 3/26; C08L 83/07; C08L 83/10

(52) U.S. Cl. 524/425

(57) ABSTRACT

A silicone rubber composition comprising an organopolysiloxane having a viscosity of at least 250,000 mPa·s at 25° C., treated filler and a curing agent is described. The composition is substantially free of reinforcing silica fillers and the filler comprises calcium carbonate treated with a treating agent having the formula: R⁴H_{3-d}SiO[(R⁴₂SiO)_{f}(R⁴HSiO)_{g}]SiR⁴_{d}H_{3-d} wherein in each formula, R⁴ represents an optionally substituted hydrocarbon group containing 1-6 carbon atoms; H is hydrogen, d is zero or an integer from 1 to 3; and f and g are independently is zero or an integer which treating agent has at least one Si—H groups and a viscosity of from 5 to 500 mPa·s at 25° C.

This invention is related to filled silicone rubber compositions containing calcium carbonate which has been treated with an Si—H containing siloxane polymer, as a filler and a method of producing highly filled silicone rubber compositions containing the aforementioned treated calcium carbonate. In particular, it relates to the use of calcium carbonate as substantially the only filler in the silicone rubber composition.

Silicone rubbers, often referred to as silicone elastomers, are composed of three essential ingredients. These ingredients are (i) a substantially linear high molecular weight silicone polymer, (ii) one or more filler(s), and (iii) a curing agent, sometimes referred to as a crosslinking agent or a vulcanising agent. Generally, there exist two main types of silicone rubber compositions heat vulcanised, (HTV) silicone rubber and room temperature vulcanising (RTV) silicone rubber. Heat vulcanised or high temperature vulcanising (HTV) silicone rubber compositions are often further differentiated as high consistency rubber (HCR) or liquid silicone rubber (LSR) depending on uncured viscosity of the composition. The name room temperature vulcanising (RTV) silicone rubber compositions, however may be misleading as many RTV compositions require a modicum of heat to progress the reaction at a reasonable rate.

HTV silicone rubber compositions are typically prepared by mixing the substantially linear high molecular weight silicone polymer with the filler and other desired additives to form a base or raw stock. Prior to use, the base is compounded to incorporate the curing agent, other fillers, and additives such as pigments, anti-adhesive agents, plasticizers, and adhesion promoters; and it can be vulcanised by press vulcanisation, injection or transfer moulding or continuously by extrusion, to form the final silicone rubber product. For example silicone rubber compositions used for cable insulation applications are extruded by special techniques in which the silicone rubber is applied to cable cores by means of angular extruder heads.

For high consistency rubber (HCR) the substantially linear high molecular weight silicone polymer most widely employed is a very high viscosity polysiloxane. Such linear high molecular weight silicone polymers have a viscosity of 1,000,000 mPa·s or more at 25° C. Typically these linear high molecular weight silicone polymers have such high viscosities at 25° C. that they are in the form of gum like materials which have such high viscosities that the measurement of viscosity is extremely difficult and therefore they are often referred by reference to their Williams plasticity number (ASTM D926). The Williams plasticity number of high viscosity polysiloxane gum-like polymers are generally at least 30, typically they are in the range of from about 30 to 250. The plasticity number, as used herein, is defined as the thickness in millimeters×100 of a cylindrical test specimen 2 cubic cm in volume and approximately 10 mm in height after the specimen has been subjected to a compressive load of 49 Newtons for three minutes at 25° C. These polysiloxane gum-like polymers generally contain a substantially siloxane backbone (—Si—O—) to which are linked alkyl groups such as for example methyl, ethyl, propyl, isopropyl and t-butyl groups, and unsaturated groups for example alkenyl groups such as allyl, 1-propenyl, isopropenyl, or hexenyl groups but vinyl groups are particularly preferred and/or combinations of vinyl groups and hydroxyl groups to assist in their crosslinking. Such polysiloxane gum-like polymers typically have a degree of polymerisation (DP) of 500-20,000, which represents the number of repeating units in the polymer.

Historically HTV silicone rubber compositions contain one or more fillers. The fillers used are usually referred to as reinforcing fillers and non-reinforcing fillers. Reinforcing fillers impart high strength to vulcanised rubber and may comprise finely divided amorphous silica such as fumed silica and precipitated silica. Extending or non-reinforcing fillers are generally used to reduce the cost of the silicone rubber composition, and generally comprise inexpensive filler materials such as ground quartz, calcium carbonate, and diatomaceous earth. Reinforcing fillers are typically used alone or together with extending or non-reinforcing fillers. The reinforcing fillers are usually treated with organosilanes, organosiloxanes, or organosilazanes, in order to improve the physical and/or mechanical properties of the silicone rubber composition, i.e., tensile strength and compression set.

GB2355453 describes a process for hydrophobing calcium carbonate using a cyclic Si—H containing siloxane or an aqueous emulsion of a Si—H containing siloxane. WO2004031302 describes a process for treating fillers such as calcium carbonate with a two component treating agent, a functional treating agent in the form of a bis(alkoxysilylalkyl)polysulphide or a mercaptoorganosilicon compound and a hydrophobing treating agent in the form of a polyorganohydrogensiloxane. The fillers prepared in this way are made specifically for use in organic tire rubbers.

In accordance with a first embodiment of the present invention there is provided a silicone rubber composition comprising:

(i) an organopolysiloxane having a viscosity of at least 100 mPa·s at 25° C.
(ii) treated filler,
(iii) a curing agent;
which composition is substantially free of reinforcing silica fillers, characterised in that the filler comprises calcium carbonate treated with a treating agent having the formula:

R⁴_{d}H_{3-d}SiO[(R⁴₂SiO)_{f}(R⁴HSiO)_{g}]Si R⁴_{d}H_{3-d}

wherein in each formula, R⁴ represents an optionally substituted hydrocarbon group containing 1-6 carbon atoms; H is hydrogen, d is zero or an integer from 1 to 3; and f and g are independently is zero or an integer which treating agent has at least one Si—H group and a viscosity of from 5 to 500 mPa·s at 25° C.

Unless otherwise indicated all viscosity measurements are at 25° C. The composition in accordance with the invention can be utilised as a liquid silicone rubber (LSR) composition. When the composition in accordance with the present invention is an LSR the viscosity of the organopolysiloxane polymer used is from 100 to 150 000 mPa·s at 25° C. The composition in accordance with the invention can be utilised as a high consistency rubber (HCR) composition. When the composition in accordance with the present invention is an HCR, the viscosity of the organopolysiloxane polymer used is preferably at least 250 000 mPa·s at 25° C. but is typically greater than 1 000 000 mPa·s at 25° C., and has a Williams Plasticity number of at least 30. There is nothing preventing the man skilled in the art using an organopolysiloxane polymer with a viscosity of between 150 000 mPa·s and 250 000 mPa·s at 25° C. but the above ranges are preferred for LSR and HCR type compositions respectively.

As hereinbefore described the composition in accordance with the present invention composition is substantially free of reinforcing silica fillers. For the sake of this invention a reinforcing silica filler is intended to mean precipitated silica and fumed silica and any other reinforcing silica (and therefore excludes ground silica which is does not provide silicone rubber compositions with a reinforcing effect). It is to be understood that the term “substantially free” is intended to mean that the composition is essentially free of reinforcing silica fillers, such that silica fillers can only be present up to a maximum amount of 5 parts by weight per 100 parts by weight of the cumulative total weight of the polymer+treated calcium carbonate filler. Alternatively, reinforcing silica fillers are present up to a maximum amount of 3 parts by weight per 100 parts by weight of the cumulative total weight of the polymer+treated calcium carbonate filler. Alternatively, reinforcing silica fillers are present up to a maximum amount of 1 part by weight per 100 parts by weight of the cumulative total weight of the polymer+treated calcium carbonate filler. In a further alternative the composition consists of calcium carbonate as the only reinforcing filler and contains zero reinforcing silica fillers. Alternatively calcium carbonate is the only filler present in the composition. It is to be noted that a reinforcing effect is not generally noticed in the physical properties of a silicone rubber unless present in an amount of at least 25 parts by weight of reinforcing filler per 100 parts by weight of polymer. Hence at the levels permitted the reinforcing silica fillers present will have minimal or no reinforcing effect on the physical properties of the silicone rubber. As will be discussed in more detail below when present precipitated silica and/or fumed silica are used for their properties of rheology modifiers. Essentially the reinforcing effect which can be seen in compositions as described herein is provided by the reinforcing properties of calcium carbonate.

The organopolysiloxane polymer comprises one or more polymers which preferably have the formula:

RR¹₂SiO[(R₂Si—R⁵—(R₂)SiO)ₛ(R₂SiO)ₓ(RZSiO)_{y}]SiRR¹₂

wherein each R is the same or different and is an alkyl group containing 1-6 carbon atoms, a phenyl group or a 3,3,3-trifluoroalkyl group; each Z is the same or different and is hydrogen or an unsaturated hydrocarbon group such as an alkenyl group or an alkynyl group; each R¹ may be the same or different and needs to be compatible with the curing agent used such that the curing agent will cause the polymer to cure. R¹ may be selected from Z, R; a hydroxyl group and/or an alkoxy group. Each R⁵ may be the same or different and is a difunctional saturated hydrocarbon group having from 1 to 6 carbon atoms, x is an integer and y is zero or an integer; s is zero or an integer between 1 and 50; and the sum of x+y+s is a number which results in a suitable polymer viscosity for the end product required. In the case of HCR compositions preferably the viscosity of the polymer is at least 500,000 mPa·s at 25° C. Alternatively In the case of HCR compositions the viscosity of the polymer is at least 1 000,000 mPa·s at 25° C. When y and/or s are integers the (R₂SiO) groups, (RZSiO) groups and/or (R₂Si—R⁵—(R₂)SiO) groups in the polymer chain are either randomly distributed or the organopolysiloxane polymer may be in the form of a block copolymer.

Preferably each R group is an alkyl group, most preferably each R is a methyl or ethyl group. Preferably when Z is an alkenyl group it has between 2 and 10 carbon atoms, more preferably between 2 and 7 carbon atoms, preferred examples being vinyl or hexenyl groups. R⁵ may be, for example, —CH₂—, —CH₂CH₂— and —CH₂CH₂CH₂— but most preferably each R⁵ is —CH₂CH₂—.

In one preferred embodiment of the present invention in which the composition is an HCR composition the organopolysiloxane constituent of the composition may be a mixture of two or more organopolysiloxanes such as a two component mixture having the following formulae:

RR¹₂SiO[(R₂Si—R⁵—(R₂)SiO)ₛ(R₂SiO)ₓ(RZSiO)_{y}]SiRR¹₂ (1)

and

RR¹₂SiO[(R₂Si—R⁵—(R₂)SiO)ₛ(R₂SiO)ₓ(RZSiO)_{y]SiRR}¹₂ (2)

wherein each R is the same or different and is as described above and each R¹ is the same or different and is as described above; x, y and s are as previously defined and the value of x¹ y¹ and s¹ are in the same ranges as x, y and s respectively but at least one of x, y and s has a different value from the value of x¹ y¹ and s¹ respectively. Preferably at least 25% of R¹ groups are Z groups, most preferably alkenyl groups and a viscosity of the polymer mixture of at least 500,000 mPa·s at 25° C., alternatively at least 1 000,000 mPa·s at 25° C. with polymer (1) having a degree of polymerisation (DP) i.e. the value of x or the sum of x and (y and/or s when present) of at least 1,000 and polymer (2) having a DP i.e. the value of x¹ or the sum of x¹ and y¹ and/or s¹ (when present) of at least 100.

Hence, the composition may comprise a mixture of two high viscosity organopolysiloxane polymers with the formulae:

Me₂ViSiO[(Me₂SiO)ₓ(MeViSiO)_{y}]SiMe₂Vi

and

Me₂ViSiO[(Me₂SiO)ₓ¹]SiMe₂Vi

wherein Me represents the methyl group (—CH₃), Vi represents the vinyl group (CH₂═CH—), the value of the sum of x and y is at least 1,000 and the value of x¹ is at least 1000.

Alternatively in another preferred embodiment the organopolysiloxane comprises a mixture of a two components having the following formulae:

RR¹₂SiO[(R₂SiO)ₓ(RZSiO)_{y}(R₂Si—R⁵—(R₂)SiO)ₛ]SiRR¹₂

and

RR¹₂SiO[(R₂SiO)_{X}¹(RZSiO)_{y}¹]SiRR¹₂

wherein, in each formula, R Z and R¹ are as described above and x, y, s, x¹ and y¹ are as previously described and the viscosity of the mixture has a value of at least 500,000 mPa·s at 25° C., alternatively at least 1 000,000 mPa·s at 25° C. with the value of x or the sum of x and y and/or s (when either or both are present) being at least 1,000 and the value of x¹ and y¹ being between 100 and 1000. Preferably at least 25% of R¹s are Z groups, most preferably alkenyl groups and the value of x or the sum of x (and y and/or s when present) provides a viscosity of the polymer mixture of at least 500,000 mPa·s at 25° C., alternatively at least 1 000,000 mPa·s at 25° C. Typically the value of x or the sum of x and y and/or s (when present) is at least 1,000.

The inventors have surprisingly identified that calcium carbonate may be used as the sole reinforcing filler in a silicone rubber composition. As noted, it is an essential feature of the present invention to use a treated calcium carbonate filler, to render the filler(s) hydrophobic and therefore easier to handle and obtain a homogeneous mixture with the other components in the composition in accordance with the present invention. Hydrophobing the calcium carbonate results in the resulting hydrophobically modified calcium carbonate is easily wetted by the silicone polymer. Hydrophobically modified calcium carbonate does not clump, and therefore is easily homogeneously incorporated into the silicone polymer. This results in improved room temperature mechanical properties of the uncured compositions. Furthermore, the surface treated fillers give a lower conductivity than untreated or raw material.

Treated calcium carbonate filler comprises the majority of filler present in the composition and is present in an amount of from about 5 to 200 parts by weight per 100 parts by weight of polymer, more preferably 30-150 parts by weight per 100 parts by weight of the polymer.

In accordance with the present invention the treating agent has the following formula:

R⁴_{d}H_{3-d}SiO[(R⁴₂SiO)_{f}(R⁴HSiO)_{g}]SiR⁴_{d}H_{3-d}

wherein, each R⁴ independently represents an optionally substituted hydrocarbon group containing 1-6 carbon atoms; H is hydrogen, d is zero or an integer from 1 to 3; and f and g are independently is zero or an integer which treating agent has at least one Si—H groups and a viscosity of from 5 to 500 mPa·s at 25° C. Preferably the treating agent is a trimethylsilyl terminated methyl hydrogen siloxane having a viscosity of from 10 to 500 mPa·s at 25° C. Preferably f+g is >10. Alternatively f+g is >25.

R⁴ is preferably an optionally substituted hydrocarbon group. Alternatively R⁴ is an alkyl group which is optionally substituted. For the purpose of this application “Substituted” means one or more hydrogen atoms in a hydrocarbon group has been replaced with another substituent. Examples of such substituents include, but are not limited to, halogen atoms such as chlorine, fluorine, bromine, and iodine; halogen atom containing groups such as chloromethyl, perfluorobutyl, trifluoroethyl, and nonafluorohexyl; oxygen atoms; oxygen atom containing groups such as (meth)acrylic and carboxyl; nitrogen atoms; nitrogen atom containing groups such as amino-functional groups, amido-functional groups, and cyano-functional groups; sulphur atoms; and sulphur atom containing groups such as mercapto groups. Alternatively one or more R⁴ groups may be an unsaturated hydrocarbon group such as an alkenyl group.

Hence the treating agent may have the following formula

R⁹ₘR¹⁰ₜH₃₋ₘ₋ₜSiO[(R⁹R¹⁰SiO)_{f}(R⁹HSiO)_{g}]SiR⁹ₘR¹⁰ₜH₃₋ₘ₋ₜ

Wherein each R⁹ is an optionally substituted alkyl group and each R¹⁰ is R⁹ or an unsaturated hydrocarbon group. Preferably one or more R¹⁰ groups is an alkenyl group such as vinyl, propenyl, isopropenyl or hexenyl and/or one or more R¹⁰ groups are alkynyl groups, preferably in such a case f>0, m is zero or an integer between 1 and 3 and t is zero or an integer between 1 and 3 but preferably t is 0, 1 or 2 and m+t 53, alternatively m+t=3, alternatively m=3. Alternatively each R¹⁰ group is an alkenyl group such as a vinyl group in which case in a further alternative m=2 and t=1. When R¹⁰ is present the treating agent may comprise a block copolymer or randomly distributed copolymer comprising two or more of alkylhydroygensiloxane groups, dialkylsiloxane groups and alkylalkenylsiloxy groups. Hence, the treating agent may be selected from a block copolymer or randomly distributed copolymer having a polymer backbone containing:
(i) alkylhydroygensiloxane groups and dialkylsiloxane groups, or
(ii) alkylhydroygensiloxane groups and alkylalkenylsiloxy groups; or
(iii) alkylhydroygensiloxane groups dialkylsiloxane groups and alkylalkenylsiloxy groups.

Alternatively the treating agent is selected from a block copolymer or randomly distributed copolymer having a polymer backbone consisting of:
(i) alkylhydroygensiloxane groups and dialkylsiloxane groups, or
(ii) alkylhydroygensiloxane groups and alkylalkenylsiloxy groups; or
(iii) alkylhydroygensiloxane groups dialkylsiloxane groups and alkylalkenylsiloxy groups.

The treating agent in accordance with the present invention is used to render the calcium carbonate filler hydrophobic and as such more easily mixed into the siloxane composition. It has been identified as discussed below in the Examples that untreated calcium carbonate inhibits the functionality of organic peroxide catalysts, often used to cure compositions as hereinbefore described. The provision of the above treating agent not only renders the calcium carbonate filler hydrophobic, it has also been found that it can prevent peroxide catalyst inhibition caused by interaction between calcium carbonate and organic peroxides. This appears to be particularly improved in instances where the treating agent contains one or more, preferably several sterically unhindered alkenyl groups (R¹⁰). Without being bound to the current theory it is believed that the Si—H groups in the treating agent chemically interact with the calcium carbonate surface. The presence of alkenyl groups in the treating agent provides additional sites for crosslinking during curing of the composition and this in turn provides improved mechanical performances of the cured silicone elastomer made from the above composition. Minimal, alternatively zero, interactions occur between the Si—H groups in the treating agent and the unsaturated groups of R¹⁰, when present in the treating agent.

Preferably when treated approximately 1 to 10% by weight of the treated calcium carbonate filler will be treating agent. Alternatively, the treating agent will be from 2.5 to 10% weight of the treated calcium carbonate filler. The filler may be pre-treated before addition into the composition or may be treated in situ during mixing with the polymer.

A curing agent, as noted above, is required and compounds which can be used herein include organic peroxides such as dialkyl peroxides, diphenyl peroxides, benzoyl peroxide, 1,4-dichlorobenzoyl peroxide, paramethyl benzoyl peroxide, 2,4-dichlorobenzoyl peroxide, di-t-butyl peroxide, dicumyl peroxide, tertiary butyl-perbenzoate, monochlorobenzoyl peroxide, ditertiary-butyl peroxide, 2,5-bis-(tertiarybutyl-peroxy)-2,5-dimethylhexane, 1,1-bis(t-butylperoxy)-3,3,5-trimethylcyclohexane tertiary-butyl-trimethyl peroxide, tertiary-butyl-tertiary-butyl-tertiary-triphenyl peroxide, and t-butyl perbenzoate. The most suitable peroxide based curing agents are benzoyl peroxide, 2,4-dichlorobenzoyl peroxide, di-t-butyl peroxide, and dicumyl peroxide. Organic peroxides such as the above are particularly utilised when R¹ in the polymer as defined above is an alkyl group but the presence of some unsaturated hydrocarbon groups per molecule is preferred. It may also be used as the curing agent when R¹ is Z as hereinbefore described.

These organic peroxides may be formed into a paste by dispersing in a silicone oil for ease of introduction into the composition. It is recommended that they are be used in an amount of 0.1 to 10 parts by weight, preferably 0.5 to 2.0 parts by weight, per 100 parts by weight of polymer.

In the case when R¹ is a hydroxy group or an alkoxy group the curing agent may comprise a suitable condensation reaction catalyst alone or in combination with a cross-linking material which undergoes a condensation reaction with the hydrolysable polymer end groups. Typically this means of cure is not preferred for the present invention.

The present compositions can also be cured and/or crosslinked by a hydrosilylation reaction catalyst in combination with an organohydrogensiloxane as the curing agent instead of an organic peroxide, providing each polymer molecule contains at least two unsaturated groups suitable for cross-linking with the organohydrogensiloxane. These groups are typically alkenyl groups, most preferably vinyl groups. To effect curing of the present composition, the organohydrogensiloxane must contain more than two silicon bonded hydrogen atoms per molecule. The organohydrogensiloxane can contain, for example, from about 4-200 silicon atoms per molecule, and preferably from about 4 to 50 silicon atoms per molecule and have a viscosity of up to about 10 Pa·s at 25° C. The silicon-bonded organic groups present in the organohydrogensiloxane can include substituted and unsubstituted alkyl groups of 1-4 carbon atoms that are otherwise free of ethylenic or acetylenic unsaturation. Preferably each organohydrogensiloxane molecule comprises at least 3 silicon-bonded hydrogen atoms in an amount which is sufficient to give a molar ratio of Si—H groups in the organohydrogensiloxane to the total amount of alkenyl groups in polymer of from 1/1 to 10/1.

Preferably the hydrosilylation catalyst is a platinum group metal based catalyst selected from a platinum, rhodium, iridium, palladium or ruthenium catalyst. Platinum group metal containing catalysts useful to catalyse curing of the present compositions can be any of those known to catalyse reactions of silicon bonded hydrogen atoms with silicon bonded alkenyl groups. The preferred platinum group metal for use as a catalyst to effect cure of the present compositions by hydrosilylation is platinum. Some preferred platinum based hydrosilation catalysts for curing the present composition are platinum metal, platinum compounds and platinum complexes. Representative platinum compounds include chloroplatinic acid, chloroplatinic acid hexahydrate, platinum dichloride, and complexes of such compounds containing low molecular weight vinyl containing organosiloxanes. Other hydrosilylation catalysts suitable for use in the present invention include for example rhodium catalysts such as [Rh(O₂CCH₃)₂]₂, Rh(O₂CCH₃)₃, Rh₂(C₈H₁₅O₂)₄, Rh(C₅H₇O₂)₃, Rh(C₅H₇O₂)(CO)₂, Rh(CO)[Ph₃P](C₅H₇O₂), RhX₃[(R³)₂S]₃, (R²₃P)₂Rh(CO)X, (R²₃P)₂Rh(CO)H, Rh₂X₂Y₄, HₐRh_{b}olefin_{c}Cl_{d}, Rh(O(CO)R³)₃₋ₙ(OH)ₙ where X is hydrogen, chlorine, bromine or iodine, Y is an alkyl group, such as methyl or ethyl, CO, C₈H₁₄ or 0.5 C₈H₁₂, R³ is an alkyl radical, cycloalkyl radical or aryl radical and R² is an alkyl radical an aryl radical or an oxygen substituted radical, a is 0 or 1, b is 1 or 2, c is a whole number from 1 to 4 inclusive and d is 2, 3 or 4, n is 0 or 1. Any suitable iridium catalysts such as Ir(OOCCH₃)₃, Ir(C₅H₇O₂)₃, [Ir(Z¹)(En)₂]₂, or (Ir(Z¹)(Dien)]₂, where Z¹ is chlorine, bromine, iodine, or alkoxy, En is an olefin and Dien is cyclooctadiene may also be used.

The platinum group metal containing catalyst may be added to the present composition in an amount equivalent to as little as 0.001 part by weight of elemental platinum group metal, per one million parts (ppm) of the composition. Preferably, the concentration of platinum group metal in the composition is that capable of providing the equivalent of at least 1 part per million of elemental platinum group metal. A catalyst concentration providing the equivalent of about 3-50 parts per million of elemental platinum group metal is generally the amount preferred.

To obtain a longer working time or “pot life”, the activity of hydrosilylation catalysts under ambient conditions can be retarded or suppressed by addition of a suitable inhibitor. Known platinum group metal catalyst inhibitors include the acetylenic compounds disclosed in U.S. Pat. No. 3,445,420. Acetylenic alcohols such as 2-methyl-3-butyn-2-ol and 1-ethynyl-2-cyclohexanol constitute a preferred class of inhibitors that suppress the activity of a platinum-based catalyst at 25° C. Compositions containing these catalysts typically require heating at temperatures of 70° C. or above to cure at a practical rate. Room temperature cure is typically accomplished with such systems by use of a two-part system in which the crosslinker and inhibitor are in one of the two parts and the platinum is in the other part. The amount of platinum is increased to allow for curing at room temperature.

Inhibitor concentrations as low as one mole of inhibitor per mole of platinum group metal will in some instances impart satisfactory storage stability and cure rate. In other instances inhibitor concentrations of up to 500 or more moles of inhibitor per mole of platinum group metal are required. The optimum concentration for a given inhibitor in a given composition can readily be determined by routine experimentation.

As hereinbefore described the composition of the present invention is substantially free of reinforcing silica fillers. However the composition may comprise up to 5 parts per weight per 100 parts by weight of polymer+treated calcium carbonate of a rheology modifier. Preferably when present the rheology modifier is present in an amount of from 1 to 3 parts by weight per 100 parts by weight of polymer+treated calcium carbonate. The rheology modifier may comprise polytetrafluoroethylene (PTFE), boric acid, amorphous precipitated or fumed silica. It is to be understood that the amount of silica present within the ranges permitted are such that it is present in such low amounts so as to have a negligible effect on the physical properties of the resulting composition.

Whilst the composition may also be free of all other fillers, the composition may comprise additional fillers (other than silica reinforcing fillers) such as finely divided additional non-reinforcing fillers such as crushed quartz, diatomaceous earths, barium sulphate, iron oxide, titanium dioxide and carbon black, talc, wollastonite. Other fillers which might be used alone or in addition to the above include aluminite, calcium sulphate (anhydrite), gypsum, calcium sulphate, magnesium carbonate, clays such as kaolin, aluminium trihydroxide, magnesium hydroxide (brucite), graphite, copper carbonate, e.g. malachite, nickel carbonate, e.g. zarachite, barium carbonate, e.g. witherite and/or strontium carbonate e.g. strontianite, halloysite, sepiolite and/or attapulgite.

Aluminium oxide, silicates from the group consisting of olivine group; garnet group; aluminosilicates; ring silicates; chain silicates; and sheet silicates. The olivine group comprises silicate minerals, such as but not limited to, forsterite and Mg₂SiO₄. The garnet group comprises ground silicate minerals, such as but not limited to, pyrope; Mg₃Al₂Si₃O₁₂; grossular; and Ca₂Al₂Si₃O₁₂. Aluminosilicates comprise ground silicate minerals, such as but not limited to, sillimanite; Al₂SiO₅; mullite; 3Al₂O₃.2SiO₂; kyanite; and Al₂SiO₅. The ring silicates group comprises silicate minerals, such as but not limited to, cordierite and Al₃(Mg,Fe)₂[Si₄AlO₁₈]. The chain silicates group comprises ground silicate minerals, such as but not limited to, wollastonite and Ca[SiO₃].

The sheet silicates group comprises silicate minerals, such as but not limited to, mica; K₂Al₁₄[Si₆Al₂O₂₀](OH)₄; pyrophyllite; Al₄[Si₈O₂₀](OH)₄; talc; Mg₆[Si₈O₂₀](OH)₄; serpentine for example, asbestos; Kaolinite; Al₄[Si₄O₁₀](OH)₈; and vermiculite.

Any or all of the additional fillers above may be treated with any of the hydrophobing treating agents in accordance with the present invention. However, they may alternatively be treated with any other suitable treating agent which renders the surface of their surface hydrophobic, examples include organic treating agents such as fatty acids and/or fatty acid esters e.g. a stearate, or organosilanes, organosilazanes such as hexaalkyl disilazane or short chain organopolysiloxane polymers e.g. short chain siloxane diols.

Other ingredients which may be included in the compositions include but are not restricted to; rheological modifiers; Adhesion promoters, pigments, colouring agents, desiccants, heat stabilizers, Flame retardants, UV stabilizers, cure modifiers, electrically and/or heat conductive fillers, blowing agents, anti-adhesive agents, handling agents, peroxide cure co-agents such as metal salts of carboxylic acids and amines, acid acceptors, water scavengers typically only when the composition is condensation cured, (typically the same compounds as those used as cross-linkers or silazanes). It will be appreciated that some of the additives are included in more than one list of additives. Such additives would then have the ability to function in all the different ways referred to.

Any suitable adhesion promoter(s) may be incorporated in a rubber composition in accordance with the present invention. These may include for example alkoxy silanes such as aminoalkylalkoxy silanes, epoxyalkylalkoxy silanes, for example, 3-glycidoxypropyltrimethoxysilane and, mercapto-alkylalkoxy silanes and γ-aminopropyl triethoxysilane, reaction products of ethylenediamine with silylacrylates. Isocyanurates containing silicon groups such as 1,3,5-tris(trialkoxysilylalkyl) isocyanurates may additionally be used. Further suitable adhesion promoters are reaction products of epoxyalkylalkoxy silanes such as 3-glycidoxypropyltrimethoxysilane with amino-substituted alkoxysilanes such as 3-aminopropyltrimethoxysilane and optionally alkylalkoxy silanes such as methyl-trimethoxysilane. epoxyalkylalkoxy silane, mercaptoalkylalkoxy silane, and derivatives thereof.

Heat stabilizers may include Iron oxides and carbon blacks, Iron carboxylate salts, cerium hydrate, barium zirconate, magnesium oxide, cerium and zirconium octoates, and porphyrins.

Flame retardants may include for example, carbon black, hydrated aluminium hydroxide, and silicates such as wollastonite, platinum and platinum compounds.

Electrically conductive fillers may include carbon black, metal particles such as silver particles any suitable, electrically conductive metal oxide fillers such as titanium oxide powder whose surface has been treated with tin and/or antimony, potassium titanate powder whose surface has been treated with tin and/or antimony, tin oxide whose surface has been treated with antimony, and zinc oxide whose surface has been treated with aluminium.

Thermally conductive fillers may include metal particles such as powders, flakes and colloidal silver, copper, nickel, platinum, gold aluminium and titanium, metal oxides, particularly aluminium oxide (Al₂O₃) and beryllium oxide (BeO); magnesium oxide, zinc oxide, zirconium oxide; Ceramic fillers such as tungsten monocarbide, silicon carbide and aluminium nitride, boron nitride and diamond.

Handling agents are used to modify the uncured properties of the silicone rubber such as green strength or processability sold under a variety of trade names such as SILASTIC® HA-1, HA-2 and HA-3 sold by Dow Corning corporation).

Peroxide cure co-agents are used to modify the properties, such as tensile strength, elongation, hardness, compression set, rebound, adhesion and dynamic flex, of the cured rubber. These may include di- or tri-functional acrylates such as Trimethylolpropane Triacrylate and Ethylene Glycol Dimethacrylate; Triallyl Isocyanurate, Triallyl Cyanurate, Polybutadiene oligomers and the like. Silyl-hydride functional siloxanes may also be used as co-agents to modify the peroxide catalysed cure of siloxane rubbers.

The acid acceptors may include Magnesium oxide, calcium carbonate, Zinc oxide and the like.

The ceramifying agents can also be called ash stabilisers and include silicates such as wollastonite.

Silicone rubber compositions having acceptable mechanical properties when compared to conventional silicone rubber compositions can be produced according to the present invention in a process which involves no heat, and which avoids the necessity to use expensive fumed silica as a reinforcing filler.

Compositions in accordance with the present invention may be prepared in accordance with any suitable method. The conventional route of preparing highly filled silicone rubber compositions is to first make a silicone rubber base by heating a mixture of reinforcing filler (typically e.g. fumed silica), a treating agent for the reinforcing filler (fumed silica), and an organopolysiloxane e.g. a polysiloxane gum in a mixer. The silicone rubber base is removed from the first mixer and transferred to a second mixer where generally about 150 parts by weight of a non-reinforcing or extending filler such as ground quartz is added per 100 parts by weight of the silicone rubber base. Other additives are typically fed to the second mixer such as curing agents, pigments and colouring agents, heat stabilizers, anti-adhesive agents, plasticisers, and adhesion promoters. This route may also be utilised for compositions of the present invention with the reinforcing silica filler being replaced by the filler of the present invention.

However, in a preferred embodiment of the present invention there is provided a method of making a treated calcium carbonate containing silicone rubber composition consisting essentially of the steps of (i) mixing an organopolysiloxane polymer and treated calcium carbonate under room temperature conditions, the mixture prepared in (i) being free of reinforcing silica fillers; (ii) adding a curing agent to the mixture in (i); and curing the mixture in (ii) at a temperature above room temperature by the application of heat.

It is to be understood that room temperature conditions means atmospheric pressure and a room temperature at normal ambient temperature of 20-25° C. It is a major advantage in the case of the present invention that heat is not required to be added during step (i) as is required when undertaking the in-situ treatment of reinforcing fillers. As in all mixing processes the effect of mixing will generate heat but mixing in the case of the present invention will not require any additional heat input.

Because calcium carbonate disperses much more easily than fumed silica in polysiloxane gums, the total mixing cycle is considerably reduced, giving much greater mixer utilization. In addition, since calcium carbonate is a semi-reinforcing filler, it is capable of providing a finished composition having adequate mechanical properties. However, because calcium carbonate is only semi-reinforcing, a higher loading level needs to be used than would be the case for fumed silica. On the other hand, because of the lower cost of calcium carbonate compared to silica, it is not necessary to use a large amount of calcium carbonate to obtain the right level of economic attractiveness for the finished composition. Preferably the ratio of treated calcium carbonate to organopolysiloxane is from 1:2 to 2:1. Thus, one is enabled to use, for example, about 100 parts by weight of calcium carbonate in 100 parts by weight of the organopolysiloxane e.g. polysiloxane gum, without using fumed silica.

The same level of mechanical properties can thereby be obtained as with finished compositions containing fumed silica. Furthermore, the elimination of fumed silica means that no heating is required, and the whole compounding process can be carried out in a single mixer. In addition, the incorporation time for calcium carbonate is much higher than for fumed silica, with the result that mixer capacity is increased by utilizing the faster throughput. Finally calcium carbonate has a much higher bulk density than fumed silica, which allows much improved ease of handling and storage.

These finished calcium carbonate containing silicone rubber compositions are useful in applications such as silicone profile extrusions, wire and cable coatings, glazing, and for construction gaskets. Specific examples include the use of this product in window glazing gaskets, wire and cable such as plenum or safety cable sheathing applications, double glazing spacer gaskets. The only requirement relative to its use is that the finished composition have a property profile roughly equivalent to that acceptable for the particular application. The composition of the present invention may also be used in the production of silicone rubber sponges with the addition of a suitable foaming agent. Any suitable foaming agent may be used. The resulting product is particularly useful for manufacturing insulating glazing spacer gaskets.

The following examples are set forth in order to illustrate the invention in more detail. As used herein, the term room temperature is intended to mean the normal ambient temperature of from 20-25° C. All viscosities were measured at 25° C. unless otherwise indicated.

### EXAMPLE 1

### Preparation of Model Silicone Rubber Compounds with Precipitated Calcium Carbonate (PCC)

A mixture of 3 components was prepared by placing them in a Brabender Internal mixer at room temperature and allowing them to mix for 20 minutes at a mixer blade speed of 50 RPM. No external heating was applied to the mixer and after 20 mins the temperature of the mixer contents had risen to about 50° C.

The 3 components in the mixer were:
(i) Polymer A, a dimethylvinylsiloxy terminated dimethylsiloxane-methylvinylsiloxane co-polymer in which the molar ratio of dimethylsiloxane units to methylvinylsiloxane units was 99.82:0.18 and having an average degree of polymerisation (dp) of 7,000.
(ii) Polymer B, a dimethylvinylsiloxy terminated polydimethylsiloxane having an average degree of polymerisation (dp) of 7,000.
(iii) A commercially available grade of untreated precipitated calcium carbonate (PCC), SOCAL® 31 purchased from Solvay Advanced Functional Minerals, Functional Additives Division (hereafter referred to as Solvay). SOCAL® 31 has a surface area as determined by BET surface area measurement using nitrogen absorption of approximately 30 m²g⁻¹. It consists of primary rhombohedral particles with a longest dimension of approximately 100 nm. The primary particles are agglomerated together to form large, approximately spherical, aggregate particles with a fractal surface approximately 10 μm in diameter.

The proportion of each component in the mixture was Polymer A (21.25% wt), Polymer B (21.25% wt) and PCC (57.5% wt). The resulting mixture is referred to as Compound X.

To compound X was added a peroxide cross-linking agent used to cure the rubber compound. The peroxide was chosen from either 2,4 dichlorobenzoyl peroxide or 2,5-Dimethyl-2,5,di(tert.butylperoxy)hexane. The 2,4 dichlorobenzoyl peroxide was used in the form of a 50% wt dispersion in a high viscosity polydimethylsiloxane fluid (the combination is henceforth referred to as Curing Agent A). The 2,5-Dimethyl-2,5,di(tert.butylperoxy)hexane was used in the form of a 40% wt dispersion in a high viscosity polydimethylsiloxane fluid(the combination is henceforth referred to as Curing Agent B).

When using Curing Agent A, Curing Agent A was added to Compound X in the amount of 1.2 parts weight per 100 parts weight of Compound X. When using Curing Agent B, Curing Agent B was added to Compound X in the amount of 1.0 parts weight per 100 parts weight of Compound X. Both curing agents were usually added directly to Compound X while the compound was still mixing in the Brabender mixer. Alternatively the Curing agents were added to Compound X by mixing the desired amount of curing agent into Compound X using a two roll mill.

The resulting silicone rubber compositions were press moulded under a pressure of 2 MPa in a 2 mm thick mould at a temperature sufficiently high to cause the curing agents to crosslink the rubber compound to form a solid rubber sheet (cure). In the case of Curing Agent A the moulding was carried out at a temperature of 116° C. for 5 minutes. In the case of Curing Agent B the moulding was carried out at a temperature of 160° C. for 10 minutes. After cure with Curing Agent A the resultant silicone rubber sheet was further processed by heating in an oven for 4 hours at 200° C. For silicone rubber sheets made using Curing Agent B no further heat treatment was carried out.

Specimens were cut from the resultant silicone rubber sheets and used to determine the resistance to tearing, the tensile strength and elongation to break (DIN 53 504) and the Shore A hardness (ASTM D2240). The results obtained are listed in Table 1.

TABLE 1

| Compound | Curing Agent | Result |
|---|---|---|
| A | A | Did not cure |
| A | B | Did not cure |

Hence, it will be appreciated that compositions as used in example 1, containing untreated calcium carbonate filler do not cure with the peroxide catalysts utilised.

### EXAMPLE 2

### Silicone Rubber Compounds Made with Commercially Available Pre-Treated PCC

Four grades of treated PCC were obtained from Solvay. The grades were SOCAL® 311, SOCAL®312, and SOCAL® 322 which are all pre-treated versions of SOCAL® 31 as used in example 1 above. The exact nature of the treating agents and the loading of the treating agents were not disclosed apart from the fact that they were based on stearic acid and calcium salts of stearic acid. The latter materials are standard treating agents widely used on PCC to aid dispersion and powder flow. SOCAL® 311, SOCAL® 312, and SOCAL® 322 were used to make silicone rubber compounds following the process described in Example 1 above. The results obtained are listed in Table 2.

TABLE 2
Silicone rubber compounds made with stearate and stearic
acid treated PCC

| | SOCAL ® | SOCAL ® | SOCAL ® | SOCAL ® |
|---|---|---|---|---|
| Grade | 31 | 311 | 312 | 322 |
| | Curing Agent A | | | |
| Shore A | No cure | No cure | No cure | No cure |
| hardness | | | | |
| Tensile | — | — | — | — |
| strength | | | | |
| Elongation at | — | — | — | — |
| break | | | | |
| Tear strength | — | — | — | — |
| | Curing Agent B | | | |
| Shore A | — | No cure | 50 | 52 |
| hardness | | | | |
| Tensile | — | — | 2.4 | 2.7 |
| strength | | | | |
| Elongation at | — | — | 678 | 730 |
| break | | | | |
| Tear strength | — | — | 10.7 | 10.9 |

None of the silicone rubber compounds made with stearic acid and stearate salt treated PCC could be cured with curing agent A. Two of the stearate and stearic acid treated PCC compounds (SOCAL 312 and 322) cured with curing agent B. No cure occurred in the case of compound made with SOCAL 311 with curing agent B.

### EXAMPLE 3

### Silicone Rubber Compounds Made with Treated PCC

Untreated PCC (SOCAL® 31) was treated with a variety of treating agents as depicted in Table 3a below. The process used for treating the PCC was as follows:—

PCC was placed into a domestic food mixer. To the mixer was also added the desired amount of the treating agent. The two components were then mixed until it was judged that the treating agent was homogeneously dispersed throughout the PCC powder. The physical dispersion of PCC and treating agent was then placed into an oven at 120° C. for a period of at least 12 hours. The treated material was then removed from the oven and allowed to cool to room temperature. In each case 5% wt of the treating agent was used to treat the PCC (Table 3).

TABLE 3a
Treating agents used to treat PCC in Example 3

| PCC sample | Description |
|---|---|
| B1 | Tetramethyltetrahydrogen octacyclosiloxane |
| B2 | Trimethylsiloxy end-blocked methyhydrogensiloxane |
| | (dp = 56) |
| C1 (comparative) | OH end-blocked polydimethylsiloxane |
| | (dp = 10 (average) |
| | OH content = 8-12% wt |
| D1 (comparative) | Methyltrimethoxysilane |
| D2 (comparative) | Vinyltrimethoxysilane |

Subsequent to the above treatment process each treated filler was introduced into a silicone rubber compound prepared as described in Example 1 above. The resulting silicone rubber products were analysed for their physical properties and the results are given in Table 3b

TABLE 3b
PCC Silicone rubber compounds made using PCC treated
with the treating agents from Table 3a

| | PCC sample | | | | |
|---|---|---|---|---|---|
| | B1 | B2 | C1 | D1 | D2 |
| | Curing Agent A | | | | |
| Shore A Hardness | 62 | 61 | No cure | No cure | No cure |
| Tensile strength (MPa) | 3.0 | 4.1 | | | |
| Elongation at break (%) | 144 | 212 | | | |
| Tear strength (kNm⁻¹) | 12.8 | 13.8 | | | |
| | Curing Agent B | | | | |
| Shore A Hardness | 66 | 67 | 46 | No cure | No cure |
| Tensile strength (MPa) | 3.0 | 4.7 | 1.6 | | |
| Elongation at break (%) | 139 | 241 | 733 | | |
| Tear strength (kNm⁻¹) | 11.4 | 12.1 | 8.3 | | |

The results for Example 3 show that the methylhydrogensiloxane type treating agents (B1 & B2) gave superior cured properties when used to treat PCC compared to the other treating agents tried.

### EXAMPLE 4

### Silicone Rubber Compounds Made with PCC Treated with B2 (Trimethylsiloxy End-Blocked Methyhydrogensiloxane (Dp=56))

An untreated PCC with a BET surface area of about 70 m²g⁻¹ was treated using the treating process described in Example 3 using treating agent B2. The resulting treated PCC was used to make rubber compounds as using the process described in Example 1 with the slight compositional changes as follows:

Polymer A 25% by weight

Polymer B 25% by weight

Treated PCC was 50% by weight.

Subsequent to cure with curing Agent B the physical properties of the resulting products were analysed and the results obtained are listed in Table 4.

TABLE 4
Silicone rubber compounds made with PCC treated with B2

| | Curing Agent B | | | |
|---|---|---|---|---|
| Treatment level (% wt) | 0 | 1 | 2 | 5 |
| Shore A hardness | — | 49 | 56 | 63 |
| Tensile strength (MPa) | — | 1.6 | 1.2 | 3.1 |
| Elongation at break (%) | — | 475 | 216 | 279 |
| Tear strength (kNm⁻¹) | — | 8.7 | 7.8 | 12.2 |

Increasing the level of treating agent, at least up to 5% wt, improves the hardness, tensile strength and tear resistance of the compounds when cured with curing agent B.

### EXAMPLE 5

### Silicone Rubber Compounds Made from PCC Treated with >5% Wt B2

The untreated PCC of Example 5 was treated with 5% wt and 10% wt of the treating agent B2 and the method described in Example 3 above. It was then compounded into a rubber formulation and tested exactly as described in Example 1. The results listed in Table 5, indicate that there is no need to use more than 5% wt of the treating agent to get optimum Shore A hardness and tear strength of the rubber compound when using Curing Agent B.

TABLE 5
Silicone rubber compounds made with PCC treated with
treating agent B2

| | Curing agent B | | |
|---|---|---|---|
| Treatment level (% wt) | 0 | 5 | 10 |
| Shore A hardness | — | 74 | 75 |
| Tensile strength (MPa) | — | 3.6 | 4.5 |
| Elongation at break (%) | — | 217 | 128 |
| Tear strength (kNm⁻¹) | — | 14.8 | 12.8 |

### EXAMPLE 6

### Silicone Rubber Made with PCC Treated In Situ with Treating Agent B2

In all previous examples the PCC was pre-treated with the treating agent as described in Example 3 before being compounded into a rubber formulation as described in Example 1. In this example the untreated PCC is mixed with all the mixture components and the treating agent using the procedure described in example 1. The treating agent (B2) was used at a loading of 5% wt on the PCC. The rubber compounds were cured using curing agent B. The results (Table 7) show that In Situ treatment of the PCC is just as effective as pre-treatment of the PCC in producing curable silicone rubber compounds with useful mechanical properties.

TABLE 6
Silicone rubber PCC compounds: In Situ versus pre-treated PCC results

| Treatment Process | In Situ | Pre-treated |
|---|---|---|
| Shore A Hardness | 74 | 74 |
| Tensile Strength (MPa) | 4.0 | 3.6 |
| Elongation at break (%) | 220 | 217 |
| Tear Strength (kNm⁻¹) | 13.6 | 14.8 |

### EXAMPLE 7

### Silicone Rubber Compounds Made with PCC Treated with B2 And Cured by Hydrosilylation Cure Package

In all previous examples the silicone rubber PCC compounds described have been cured with peroxides. In this example it is shown that silicone rubber compounds made with PCC treated with methylhydrogensiloxane fluids can be cured via hydrosilylation using a Pt catalyst.

The sample described in Example 5, made with PCC treated with 10% wt of treating agent B2, was repeated but was cured with a hydrosilylation curing system replacing the peroxide catalyst with Additives A and B:
Additive A: a mixture containing 10% by weight of 1-ethynyl-1cyclohexanol inhibitor and 90% by weight of a silicone rubber base, introduced in an amount of 0.8 parts weight per 100 parts weight of the PCC rubber compound; and
Additive B: a mixture containing 0.2% wt of a platinum based compound and 99.8% wt of a silicone rubber base, in an amount of 0.5 parts weight per 100 parts weight of the PCC rubber compound.

Typically, as discussed above a crosslinking agent comprising Si—H groups is incorporated into compositions cured by hydrosilylation. A crosslinking agent was added is some compositions as indicated in Table 7. The cross-linking agent used was treating agent B2 (see example 3). The crosslinker was introduced into the composition in the form of a mixture. The crosslinker mixture consisted of 20% wt treating agent B2 and 80% by weight of silicone rubber base.

Hence, compound X of Example 1 was prepared with the proviso that the treated filler of example 5 replaced the untreated filler and then Additive A, Additive B and the crosslinker were added in the proportions identified above and in Table 7 to the compound to make a final mixture and this final mixture was then cured using the curing conditions described for curing agent B in Example 1. The properties of the resultant cured compounds are shown in Table 7.

TABLE 7
Hydrosilylation cured PCC rubber compounds

| Additive C | | | |
|---|---|---|---|
| (parts per hundred of PCC rubber compound) | 0 | 3 | 6 |
| Shore A hardness | No cure | 62 | 67 |
| Tensile Strength (MPa) | | 2.9 | 2.5 |
| Elongation at break (%) | | 157 | 68 |
| Tear strength (kNm⁻¹) | | 9.2 | 10.8 |

It is clearly shown that cure with a Platinum-catalysed hydrosilylation system is possible to produce a solid rubber product with useful mechanical properties but that the amount of sterically unhindered Si—H groups on the treated calcium carbonate are insufficient, or at least present in an insufficient amount in this example, for cure to take place in the absence of a crosslinker. However, once crosslinker is added cure takes place products with good physical properties (despite the omission of silica reinforcing fillers) are obtained.

### EXAMPLE 8

### Silicone Rubber Compounds Made with PCC Treated with Poly(Methylhydrogensiloxane-Co-Methylvinylsiloxane) Fluids

In this example the treating agent B2, described in Example 3, has been modified by insertion of methylvinylsiloxane repeat units, changes in the degree of polymerisation (dp) and the use of dimethylvinylsiloxy end groups (ViDMS) in place of trimethylsiloxy end-groups (TMS). The structural variants are listed in Table 8a.

The structural variants listed in Table 8a were used to prepare silicone rubber compounds, using treated PCC, as described in Examples 3. The treatment level of the PCC was in every case with 5% wt of the structural variant listed in Table 9. The process used for the preparation and cure of the respective compositions were as defined in Example 1 above.

TABLE 8a
methylhydrogensiloxane-co-methylvinylsiloxane treating
agent structural variants

| | Degree of | | Siloxane repeat | |
|---|---|---|---|---|
| | polymerisation | | unit type (number) | |
| Fluid | (dp) | End blocking | methylhydrogen | methylvinyl |
| B2 | 56 | TMS | 56 | 0 |
| B3 | 28 | ViDMS | 28 | 0 |
| B4 | 56 | ViDMS | 56 | 0 |
| B5 | 112 | ViDMS | 112 | 0 |
| B6 | 56 | TMS | 54 | 2 |
| B7 | 56 | TMS | 46 | 10 |
| B8 | 56 | TMS | 36 | 20 |

Results obtained with the cured rubber compounds are listed in Table 8b.

TABLE 8b
cured properties of silicone rubber PCC compounds using
the treating agents listed in Table 8a

| Structural variant | B2 | B3 | B4 | B5 | B6 | B7 | B8 |
|---|---|---|---|---|---|---|---|
| | Curing Agent A | | | | | | |
| Shore A hardness | 61 | 68 | 68 | 64 | 68 | 73 | 70 |
| Tensile strength (MPa) | 4.3 | 4.5 | 5.1 | 5.9 | 4.5 | 4.1 | 3.6 |
| Elongation at break | 220 | 250 | 281 | 251 | 206 | 166 | 194 |
| (%) | | | | | | | |
| Tear strength (kNm⁻¹) | 12.7 | 14.5 | 13.5 | 11.7 | 13.2 | 13.4 | 12.8 |
| | Curing Agent B | | | | | | |
| Shore A hardness | 74 | 72 | 74 | 71 | 75 | brittle | brittle |
| Tensile strength (MPa) | 3.6 | 3.4 | 5.1 | 4.8 | 3.4 | | |
| Elongation at break | 217 | 123 | 201 | 172 | 145 | | |
| (%) | | | | | | | |
| Tear strength (kNm⁻¹) | 14.8 | 11.9 | 11.8 | 10.9 | 12.1 | | |

The results show that in the case of cure with Curing Agent B the mixed vinyl-hydrogen methylsiloxanes don't offer any benefits over B2 alone as the treating agent for PCC. However in the case of cure with curing Agent A the use of the mixed vinyl-hydrogen methylsiloxanes results in substantially improved mechanical properties after cure compared to B2 alone as the PCC treating agent.

1. A silicone rubber composition comprising:
(i) an organopolysiloxane having a viscosity of at least 100 mPa·s at 25° C.;
(ii) treated filler,
(iii) a curing agent;
which composition is substantially free of reinforcing silica fillers, characterised in that the treated filler comprises calcium carbonate treated with a treating agent having the formula:
R⁴_{d}H_{3-d}SiO[(R⁴₂SiO)_{f}(R⁴HSiO)_{g}]SiR⁴_{d}H_{3-d}
wherein in each formula, R⁴ represents an optionally substituted hydrocarbon group containing 1-6 carbon atoms; H is hydrogen, d is zero or an integer from 1 to 3; and f and g are independently zero or an integer, the treating agent has having at least one Si—H group and a viscosity of from 5 to 500 mPa·s at 25° C.

2. A composition according to claim 1 in which the organopolysiloxane comprises one or more polymers which have the formula:
RR¹₂SiO[(R₂Si—R⁵—(R₂)SiO)ₛ(R₂SiO)ₓ(RZSiO)_{y}]SiRR¹₂
wherein each R is the same or different and is an alkyl group containing 1-6 carbon atoms, a phenyl group or a 3,3,3-trifluoroalkyl group; each Z is the same or different and is hydrogen or an unsaturated hydrocarbon group; each R¹ may be the same or different and is compatible with the curing agent used such that the curing agent will cause the polymer to cure, and R¹ is selected from Z, R; a hydroxyl group and/or an alkoxy group; each R⁵ may be the same or different and is a difunctional saturated hydrocarbon group having from 1 to 6 carbon atoms; x is an integer, y is zero or an integer; s is zero or an integer between 1 and 50.

3. A composition according to claim 1 in which the organopolysiloxane is a two component mixture comprising a mixture of two high viscosity organopolysiloxane polymers with the formulae:
Me₂ViSiO[(Me₂SiO)ₓ(MeViSiO)_{y}]SiMe₂Vi
and
Me₂ViSiO[(Me₂SiO)ₓ¹]Si Me₂Vi
wherein Me represents the methyl group (—CH₃) Vi represents the vinyl group (CH₂═CH—), the value of the sum of x and y is at least 1,000 and the value of x¹ is at least 1000.

4. A composition according to claim 1 in which the organopolysiloxane is a two component mixture having the following formulae:
RR¹₂SiO[(R₂SiO)ₓ(RZSiO)_{y}(R₂Si—R⁵—(R₂)SiO)ₛ]SiRR¹₂
and
RR¹₂SiO[(R₂SiO)ₓ¹(RZSiO)_{y}¹]SiRR¹₂
wherein, in each formula, wherein each R is the same or different and is an alkyl group containing 1-6 carbon atoms, a phenyl group or a 3,3,3-trifluoroalkyl group; each Z is the same or different and is hydrogen or an unsaturated hydrocarbon group; each R¹ may be the same or different and is compatible with the curing agent such that the curing agent will cause the polymer to cure, and R¹ is selected from Z, R; a hydroxyl group and/or an alkoxy group; x is an integer, y is zero or an integer; s is zero or an integer between 1 and 5; x¹ and y¹ are in the same ranges as x and y; and the viscosity of the mixture has a value of at least 500,000 mPa·s at 25° C. with the value of x or the sum of x and y and/or s (when either or both are present) being at least 1,000 and the value of x¹ and y¹ being between 100 and 1000.

5. A composition according to claim 1 characterised in that the calcium carbonate is treated with a trimethylsilyl terminated methyl hydrogen siloxane having a viscosity of from 10 to 500 mPa·s at 25° C.

6. A composition according to claim 1 comprising about equal amounts of polysiloxane gum and calcium carbonate.

7. A composition according to claim 1 in which the curing agent is a peroxide selected from the group consisting of benzoyl peroxide, 2,4-dichlorobenzoyl peroxide, di-t-butyl peroxide, and dicumyl peroxide.

8. A composition in accordance with claim 1 in which the curing agent is an organohydrogensiloxane curing agent, and a platinum group metal hydrosilylation catalyst is added in an amount sufficient to cure the composition.

9. A method of making a treated calcium carbonate containing silicone rubber elastomer from a composition in accordance with claim 1, which method consists essentially of the steps:
(iv) mixing an organopolysiloxane and treated calcium carbonate under room temperature conditions, and
(v) adding a curing agent to the mixture in (i); and curing the mixture in (ii) at a temperature above room temperature by the application of heat.

10. A method according to claim 9 in which room temperature is normal ambient temperature of 20-25° C.

11. (canceled)

12. A composition according to claim 1 characterised in that the silicone rubber composition is free of silica.

13. A composition according to claim 1 wherein the treated calcium carbonate is the sole reinforcing filler in the silicone rubber composition.

14. An article comprising a silicone rubber composition in accordance with claim 1, wherein the article is selected from the group consisting of silicone profile extrusions, wire and cable coatings, glazing gaskets, and construction gaskets.

15. A method for the preparation of the composition in accordance with claim 1 comprising treating calcium carbonate filler with the treating agent and subsequently introducing the pre-treated calcium carbonate filler into the organopolysiloxane prior to or simultaneously with the curing agent.

16. A method for the preparation of the composition in accordance with claim 1 comprising mixing the organopolysiloxane, calcium carbonate filler and treating agent and subsequently introducing the curing agent.

17. A silicone rubber composition comprising:
(vi) an organopolysiloxane having a viscosity of at least 100 mPa·s at 25° C.;
(vii) treated filler, and
(viii) a curing agent;
characterised in that the treated filler consists of calcium carbonate treated with a treating agent having the formula:
R⁴_{d}H_{3-d}SiO[(R⁴₂SiO)_{f}(R⁴HSiO)_{g}]SiR⁴_{d}H_{3-d}
wherein in each formula, R⁴ represents an optionally substituted hydrocarbon group containing 1-6 carbon atoms; H is hydrogen, d is zero or an integer from 1 to 3; and f and g are independently zero or an integer, the treating agent having at least one Si—H groups and a viscosity of from 5 to 500 mPa·s at 25° C.

18. A composition in accordance with claim 1 characterised in that the treating agent has the following formula
R⁹ₘR¹⁰ₜH₃₋ₘ₋ₜSiO[(R⁹R¹⁰SiO)_{f}(R⁹HSiO)_{g}]SiR⁹ₘR¹⁰ₜH₃₋ₘ₋ₜ
wherein each R⁹ is an optionally substituted alkyl group and each R¹⁰ is independently R⁹ or an alkenyl group and/or an alkynyl groups and wherein m is zero or an integer between 1 and 3, t is zero or an integer between 1 and 3 and m+t≦3.

19. A composition in accordance with claim 18 characterised in that at least one R¹⁰ group is an alkenyl group.

20. A composition in accordance with claim 19 characterised in that R⁹ is an alkyl group selected from methyl and ethyl groups and t=0, 1 or 2 and m+t=3.

21. A composition in accordance with claim 18 characterised in that the treating agent is selected from a block copolymer or randomly distributed copolymer having a polymer backbone comprising:
(ix) alkylhydroygensiloxane groups and dialkylsiloxane groups, or
(x) alkylhydroygensiloxane groups and alkylalkenylsiloxy groups; or
(xi) alkylhydroygensiloxane groups dialkylsiloxane groups and alkylalkenylsiloxy groups.
